(19) United States
(12) Patent Application Publication
(10) Pub. No.: US 2026/0017115 A1
(43) Pub. Date: Jan. 15, 2026

(54) DYNAMIC RESOURCE ALLOCATION FOR A DISTRIBUTED NODE NETWORK

(71) Applicant: Capital One Services, LLC, McLean, VA (US)

(72) Inventors: Neil GOLLAPUDI, McLean, VA (US); Payam VAEZI, McLean, VA (US); Peter Gaspare TERRANA, Mechanicsville, VA (US)

(73) Assignee: Capital One Services, LLC, McLean, VA (US)

(21) Appl. No.: 18/773,485

(22) Filed: Jul. 15, 2024

(51) Int. Cl. G06F 9/50; G06F 11/34

(52) U.S. Cl. CPC G06F 9/5072; G06F 9/5044; G06F 11/3452

(57) ABSTRACT

Methods and systems for dynamically allocating resources for a distributed node network. A system may receive a workflow comprising computer program code configured to perform one or more processes of the workflow when executed. The system may generate a set of data inputs, each data input being representative of a (a) resource allocation for allocating compute resources to the one or more nodes during performance of the one or more processes and (b) sample data on which to perform the process(es). The system may determine a performance metric value for each data input by executing at least a portion of the workflow to perform the process(es) on the sample data using the specified resource allocation. Using the generated set of data inputs, a machine learning model may be trained to identify a required resource allocation for a given set of data inputs for meeting the target performance value.

### BACKGROUND

For many computing and analysis tasks, multiple computer systems may be leveraged to perform complex processing tasks. For example, such distributed computing techniques are often used to divide the workload among multiple interconnected computers, each contributing its processing power and resources. Distributed computing is especially used for its scalability, fault tolerance, cost effectiveness and load balancing abilities. Different types of users, such as researchers, enterprises, and cloud service providers utilize distributed systems to meet their specific needs, whether to handle large datasets, to run complex simulations, or to provide scalable web services.

Many everyday services, such as those provided online, rely heavily on distributed computing. For example, distributed computing is used in healthcare where such systems may be used to analyze medical images using powerful computational resources distributed across different locations. Social media platforms rely on distributed systems to store and manage vast amounts of user-generated content, handle billions of interactions, and deliver personalized content to users in real-time. Similarly, such techniques may be used for real-time transaction processing, fraud detection and risk management.

### SUMMARY

Accordingly, systems and methods are described herein for allotment of resources among nodes of a distributed node network. Allocating resources such as CPU, memory and storage, across multiple nodes in a distributed system efficiently is important in enabling the processing on the distributed nodes to be performed correctly and in real-time. In particular, the ability to quickly scale up resource allocation on distributed nodes is important for several reasons such as handling peak loads, improved user experience, and risk management.

For example, systems often experience varying levels of demand, with occasional spikes in traffic or workload. The ability to quickly scale up resources for different nodes ensures that the system can handle these peak loads without experiencing performance degradation or downtime. On the other hand, the ability to quickly scale down resources is cost-effective for end users and node managers, as the nodes may be freed up for usage by another processing task. Fast response times to increased demands also ensure a smooth and uninterrupted user experience which may be important for client-facing applications, where delays or downtime can lead to dissatisfaction. In some circumstances where processing is crucial in emergency situations, being able to quickly scale up resources are essential.

However, conventional distributed systems are very slow to scale resource allotment among nodes. For example, many conventional distributed systems utilize a generic rule-based system for determining whether or not to increase or decrease resources for nodes which may not be specific to any type of task or processing occurring on those nodes. For example, resource allotment is based on whether or not threshold amounts of the CPU are sustained over a period of time. Because these rules are generic and non-specific to any types of processing tasks or data that is being processed, the allotment of resources is often reactive to performance, and not accurate (e.g., not enough or excess resources allotted). For example, conventional systems typically estimate maximum resource usage based on expected input data and domain knowledge of the executed tasks. However, this fails to account for unexpected samples for processing, such as when sudden peaks occur.

Therefore, methods and systems described herein may utilize machine learning trained to identify a required resource allocation for a workflow for a given set of data inputs, e.g., where the machine learning model is trained on data inputs that are generated to be representative of a diverse population of data that the workflow may be performed on. By doing so, a system may predict a resource allotment preemptively, based on sample data (e.g., of a data stream) configured to be processed, before the sample data are processed. Doing so enables the system to predict an accurate resource allotment that is needed for the specific workflow, rather than application of generic rules that provide inaccurate scaling estimates after processing inputs, e.g., without consideration to the data or specific workflow.

In particular, methods and systems herein may be used to identify and recommend a resource allotment among nodes of a distributed node network based on a prediction by the machine learning model. The machine learning model may be trained on different combinations of varying resource allocations combined with different types of sample data into the workflow. A user may indicate a performance measurement threshold, such that the machine learning model is trained to output resource allocations configured to enable processing to exceed the performance measurement threshold. In some examples, the different types of sample data may simply be volume of data inputs, but may also be differing characteristics of data, such as size, complexity, etc. of each sample. In some examples, the sample data may be synthetic and generated by the system.

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for dynamically allocating resources for a distributed node network using machine learning models, in accordance with one or more embodiments of this disclosure.

FIG. 2A illustrates an example of exemplary data inputs for training a machine learning model for dynamically allocating resources for a distributed node network, in accordance with one or more embodiments of this disclosure.

FIG. 2B illustrates an example of a recommendation for dynamically allocating resources for a distributed node network using machine learning models, in accordance with one or more embodiments of this disclosure.

FIG. 3 shows illustrative components for a system used for dynamically allocating resources for a distributed node network using machine learning models, in accordance with one or more embodiments.

FIG. 4 is a flowchart of an exemplary computer system for dynamically allocating resources for a distributed node network using machine learning models, in accordance with one or more embodiments.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

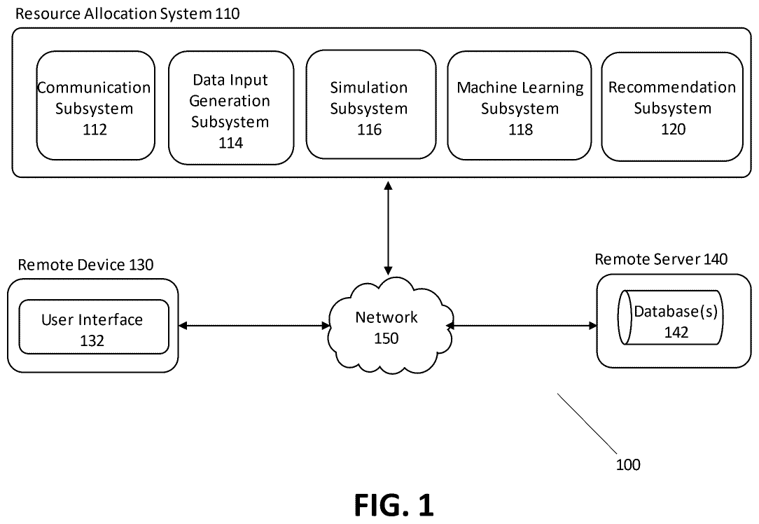

FIG. 1 shows an illustrative environment 100 for dynamically allocating resources for a distributed node network using machine learning models, in accordance with one or more embodiments of this disclosure. Environment 100 includes a resource allocation system 110 which may be used to train and execute machine learning models to identify resource allocations for nodes of a distributed node network. For example, doing so enables a system to predict a resource allocation that will perform with at least a minimum performance level based on the data that may be incoming for processing. This may avoid inaccurate or slow updates to resource allocations that are typical of conventional systems that modify allocations after data has been processed and using rules that are generic and non-specific to particular workflows and processes.

A distributed computing cluster can consist of many worker nodes that communicate with a scheduler node and optionally with each other to execute parts of a larger task. Each worker has their own resource specification (CPU cores, GPU cores, memory). During the execution of a distributed computing task, the amount of resources required in the distributed compute cluster vary largely based on the task at hand and/or the properties and size of the data being processed by the task. This makes it very difficult to correctly preconfigure the resources for the processing tasks of a workflow without manually running tests and coming up with an educated estimation. The trial and error method for manual estimation can be very time intensive for the user, and often results in a suboptimal configuration.

In particular, being able to use a machine learning model to determine an allocation may be useful for streaming data, where distributed networks may benefit from quick and dynamic scaling in resources to account for sudden peaks in volume for processing. As referred to herein, using streaming data may refer to data of a continuous nature, which is being processed, in some cases, in real-time or near real-time. In particular, the resource allocation system 110 may provide recommendations based on predictions of the machine learning model or may automatically execute or transmit commands configured to modify the allocation based on predictions of the machine learning model.

The environment may include the remote device 130, from which the system may receive requests for identifying resource allocations or training machine learning models for workflows, or to which the system may transmit notifications, e.g., to developers or operators, to provide recommendations or alert them when allocations have been modified based on the recommended allocations. In some examples, the environment may also include remote server 140 which may be used to store programmatic code for executing the workflow and may also be used to store parameters of the machine learning model(s).

The resource allocation system 110, remote server 140, and/or remote device 130 may be in communication via the network 150. Network 150 may be a wired or wireless connection such as via a local area network, a wide area network (e.g., the Internet), or a combination thereof. The resource allocation system 110 may include communication subsystem 112, data input generation subsystem 114, simulation subsystem 116, machine learning subsystem 118, and/or recommendation subsystem 120.

As described herein, the resource allocation system 110 may be used to identify a resource allocation for distributed nodes of a network for a specific workflow. For example, the resource allocation system 110 may do so by processing varying sample data with varying resource allocations at a workflow. The system may then identify performance of the workflow using the resource allocation on the given input sample data. Resource allocation system 110 may then train a machine learning model based on sample data, resource allocation, and performance. When data is streamed into the workflow for processing, the machine learning model may first use characteristics of the data to identify a resource allocation and may present the resource allocation to the user, such as an operator or developer, as a recommendation. The user may then choose to execute one or more commands for aligning the resource allocation based on the recommended resource allocation.

For example, the resource allocation system may receive a workflow, e.g., from a user, such as an operator or developer. As referred to herein, a workflow may include a programmatic workflow, and may refer to a series of automated processes and tasks, which may be orchestrated through programming (e.g., programmatic code, configuration data, etc.). In particular, a workflow as referred to herein may reference computer program code configured to perform one or more processes of the workflow when executed, wherein the workflow is configured to be deployed using one or more nodes of a distributed node cluster.

Using such workflows leverages code to automate repetitive and complex tasks, thereby increasing efficiency, reducing the likelihood of human error, and ensuring consistency and repeatability in operations. The workflow may enable systematic execution of a sequence of tasks, such as data collection, analysis, transformation, and the subsequent application of business logic or machine learning algorithms. Programmatic workflows may rely on tools and technologies such as scripting languages, workflow automation platforms and various software development frameworks. For workflows that include execution of machine learning techniques, e.g., such as for classification, anomaly detection, and/or the like, workflows may include processing steps such as extracting data, cleaning, and preprocessing data, as well as training the models and deploying them for predictions or for generation.

A user (e.g., a developer or operator) may transmit the workflow through remote device 130 via user interface 132. The resource allocation system 110 may receive the workflow at the communication subsystem 112 of the system. Communication subsystem 112 of resource allocation system 110 may include software and/or hardware components allowing for the transmission and/or receipt of information between two or more devices. For example, the communication subsystem 112 may include a wireless communication subsystem, such as a cellular radio or Wi-Fi antenna, to allow for communication over wireless networks, and/or may include a network card (e.g., a wireless network card and/or a wired network card) that is associated with software to drive the card.

As described herein, the communication subsystem 112 may receive the workflow, e.g., from a user, that includes computer program code configured to perform one or more processes of the workflow when executed, wherein the workflow is configured to be deployed using one or more nodes of a distributed node cluster. According to some examples, the communication subsystem 112 may receive the workflow from a user at a user device. The workflow may include, e.g., computer code or configuration data that, when applied or executed, perform the steps of the workflow.

The communication subsystem may also receive a target performance value for the workflow. For example, the user may specify a target performance value that the distributed node network must exceed during processing of the inputs. For example, target performance values may include any of CPU utilization, memory utilization, storage utilization, I/O throughput, network bandwidth utilization, latency, error rates, task completion time, resource availability, and/or the like. In some examples, the target performance values may comprise any combination of the CPU utilization, memory utilization, storage utilization, I/O throughput, network bandwidth utilization, latency, error rates, task completion time, and/or resource availability. For example, the values may be received as an array or data structure indicating values for different parameters.

The communication subsystem 112 may then pass the workflow and/or the one or more target performance values, or a pointer to the data in memory, to the data input generation subsystem 114, where the system may generate different data input generations on which to perform simulations at the simulation subsystem 116. The data input generation subsystem 114 may be used to generate data inputs that are representative of different combinations of resource allocations and sample data on which to perform the workflow on. By developing different combinations, the system may get a broader understanding of how changing different parameters (e.g., characteristics of samples, resources allotted) may impact processing so that the system can make predictions on what allocation should be applied to process effectively in real-time data streams.

The data input generation subsystem 114 may generate the data inputs in various ways. Each data input of the set of data inputs generated by the subsystem may be representative of a different combination of (1) resource allocations for allocating compute resources (e.g., CPU, network bandwidth, storage) to the one or more nodes during performance of the one or more processes and (2) sample data on which to perform the one or more processes.

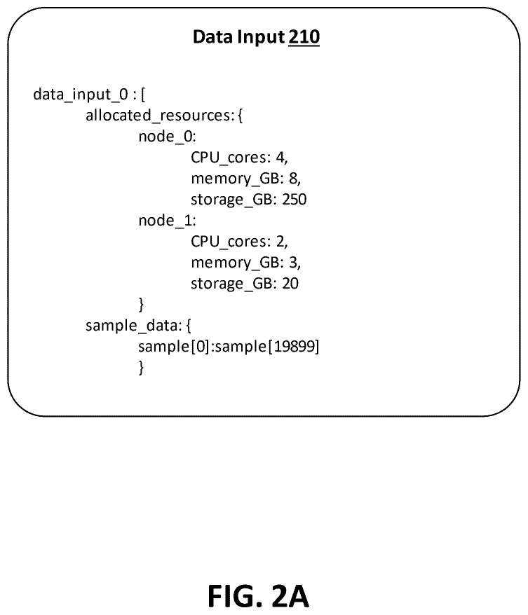

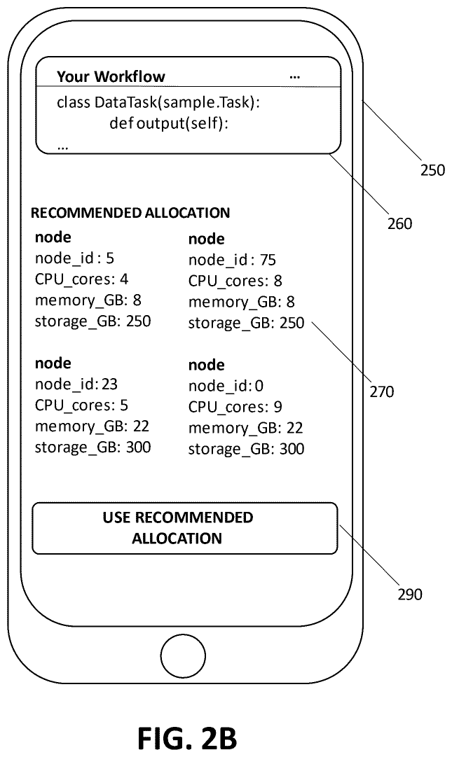

For example, FIG. 2A illustrates an example of exemplary data input 200 for training a machine learning model for dynamically allocating resources for a distributed node network, in accordance with one or more embodiments of this disclosure. The data input 200 includes an allocation for resources for two nodes labeled “node_0” and “node_1.” The first node “node 0” has a resource allocation of 4 CPU cores, 8 GB of memory and 250 GB of storage, which the second node “node_1” has a resource allocation of 2 CPU cores, 3 GB of memory and 20 GB of storage. The sample data on which to perform the workflow or at least a part of the workflow on (e.g., a stage of the workflow) using the allocation is represented in FIG. 2A as “sample_data.” The sample data references samples indexed from 0 to 19899.

In some examples, the samples may be synthetic samples generated on the system, or may be real samples previously observed, e.g., from a data stream, obtained from the database(s) 142 or obtained from local storage. According to some examples, the system may also receive, e.g., as part of a user input from a remote device, a user input indicative of a parameter on which to vary the sample data of each data input of the set of data inputs. For example, the parameters may include an amount (e.g., sample volume) of data to be processed. In this case, generating the set of data inputs may include generating a set of synthetic sample data and referencing varying amounts of sample data from the set of synthetic sample data for processing for data inputs of the set of data inputs. Alternatively, generating the set of data inputs may include accessing, from storage, one or more preexisting sets of sample data, and referencing varying amounts of sample data from the one or more preexisting sets of sample data for processing for data inputs of the set of data inputs. The samples may be varied in other ways as well, for example, the data type may be changed, data structure, data size, data distribution, data integrity and data complexity may all be used to vary the samples across different data inputs.

The data input generation subsystem 114 may then pass the data inputs, or a pointer to the data in memory, to the simulation subsystem 116, where the system may perform simulations using the data inputs. For example, the simulation subsystem 116 may initialize different node configurations of a distributed node network, initialize each node according to the resource allocation of a data input, and perform one or more processes of the workflow on the node configuration. With each specific node configuration, resource allocation, and/or sample data that is put in, the system may execute performance of the one or more processes of the workflow. The simulation subsystem 116 may determine a performance metric value for each data input of the set of data inputs. As described herein, the performance metric value may be any value of CPU utilization, memory utilization, storage utilization, I/O throughput, network bandwidth utilization, latency, error rates, task completion time, resource availability, and/or the like.

According to some embodiments, once the simulation subsystem 116 has a performance metric value associated with each resource allocation configuration and sample data, the simulation subsystem 116 may then pass the performance metric values and the corresponding resource allocation and sample data, or a pointer to the data in memory, to the machine learning subsystem 118, where the system may train the machine learning model to identify required resource allocations for data to be processed.

The machine learning subsystem 118 may be used to train to identify a required resource allocation for a given set of data inputs for meeting the target performance value using the set of data inputs and corresponding performance metric values. For example, the machine learning subsystem may be trained on the data inputs and their corresponding performance metric values in order to identify for any given data for processing, what the minimum resource allocation would be in order to perform processes of the workflow without the performance metric value dropping below, or significantly below (e.g., below by a certain percentage) what the user indicated to be the target.

The workflow may be deployed on the nodes of a distributed node network, e.g., after, or responsive to completing training of the machine learning model. For example, the workflow may be deployed by first initializing the nodes and executing at least a portion of the computer program code on the one or more nodes of the distributed node cluster. In particular, the workflow may be deployed by executing at least a portion of the computer program code on the one or more nodes of the distributed node cluster.

Once the workflow is initialized and deployed, the system may receive a stream of data comprising new sample data to be processed by the workflow (e.g., via the communication subsystem 112). The system may then input the new sample data into the machine learning model via machine learning subsystem 118, to obtain the required resource allocation for processing the new sample data at the one or more nodes. The machine learning subsystem may pass the required resource allocation, or a pointer to the data in memory, to the recommendation subsystem 120. The recommendation subsystem 120 may generate a recommendation to a user for a particular resource allocation. In some examples, the recommendation subsystem 120 may generate and/or transmit one or more commands for automatically scaling the resource allocation to match the required resource allocation.

FIG. 2B illustrates an example of a recommendation for dynamically allocating resources for a distributed node network using machine learning models, in accordance with one or more embodiments of this disclosure. For example, the recommendation may be transmitted for display onto a remote user device, e.g., via the communication subsystem 112. The recommendation may be displayed, for example on a UI of a mobile phone, e.g., having display 250. The display 250 may show the user their workflow, 260 and a recommended resource allocation 270 among nodes. The user may select to implement the recommended resource allocation by selecting an option such as option 290 to “use recommended allocation.”

In some examples, the system may further determine the performance metric value for the one or more processes of the workflow for the new sample data. Responsive to determining that the performance metric value does not exceed the target performance value, the system may perform one or more actions, such as transmitting a notification to a remote device, triggering retraining of the machine learning model, and/or terminating execution of the workflow.

In some examples, the resource allocation includes a number of computer processing units (CPUs) and generating the one or more commands may include identifying a number of CPUs to use for processing the new sample data based on the resource allocation, determining one or more identifiers corresponding to available CPUs to use in processing the new sample data, and generating at least one command comprising the one or more identifiers and the one or more processes to be executed.

In some examples, the resource allocation includes an amount of memory at each node of the one or more nodes and generating the one or more commands includes identifying the amount of memory to use for processing the new sample data based on the resource allocation, determining, for each node of the one or more nodes, a portion of the amount of memory for processing the new sample data, and generating at least one command for resource allocation, wherein the at least one command identifies each node and a corresponding portion of the amount of memory.

In some examples, the resource allocation includes a network bandwidth amount at each node of the one or more nodes. Generating the one or more commands may include identifying the network bandwidth amount to use for processing the new sample data based on the resource allocation, determining, for each node of the one or more nodes, a portion of the network bandwidth amount for processing the new sample data, and generating at least one command for resource allocation, wherein the at least one command identifies each node and a corresponding portion of the network bandwidth amount.

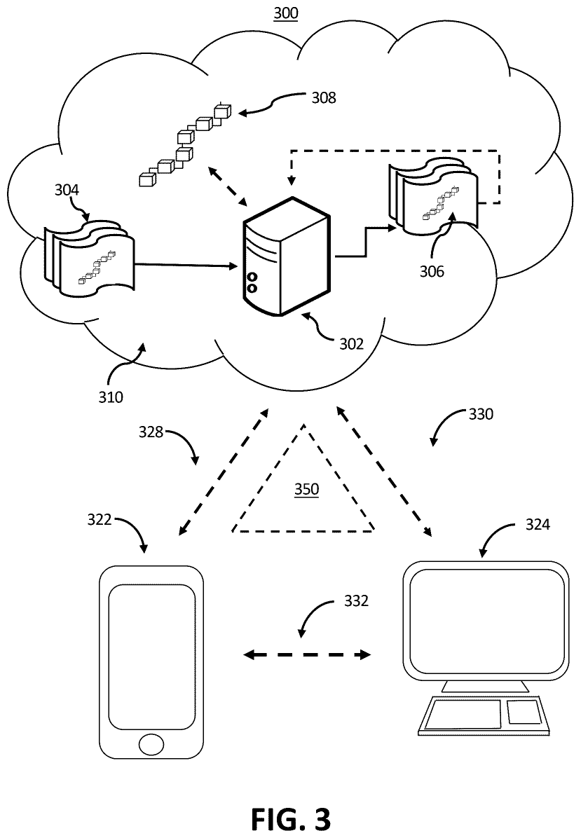

FIG. 3 shows illustrative components for a system used for dynamically allocating resources for a distributed node network using machine learning models, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310.

Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include resource allocation system 110, and components of resource allocation system 110, remote device 130, remote server 140, and/or network 150. Cloud components 310 may include model 302, which may be a machine learning model, AI model, etc. (which may be referred to collectively as “models” herein). Model 302 may take inputs 304 and provide outputs 306. The inputs may include multiple datasets, such as a training dataset and a test dataset. As described herein the machine learning model may be trained using training datasets of data inputs such as sample data, resource allocations, and subsequent processing metrics (e.g., performance metrics). After training, the machine learning model may take in inputs such as data that is streamed in for processing and the outputs 306 may include a resource allocation.

Each of the plurality of datasets (e.g., inputs 304) may include data subsets related to user data, predicted forecasts and/or errors, and/or actual forecasts and/or errors. In some embodiments, outputs 306 may be fed back to model 302 as input to train the model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., sensitive, non-sensitive information). The model 302 may also output a confidence measure for the classification.

In some embodiments, the model (e.g., model 302) may automatically perform actions based on outputs 306. In some embodiments, the model (e.g., model 302) may not perform any actions. The output of the model (e.g., model 302) may be used minimize strain on computational capacity of preprocessors when analyzing multi-modal data in real-time.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front end and back end. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their subsystems. API layer 350 may use a developer portal. API layer 350 may use strong security constraints applying WAF and DDOS protection, and API layer 350 may use RESTful APIs as standard for external integration.

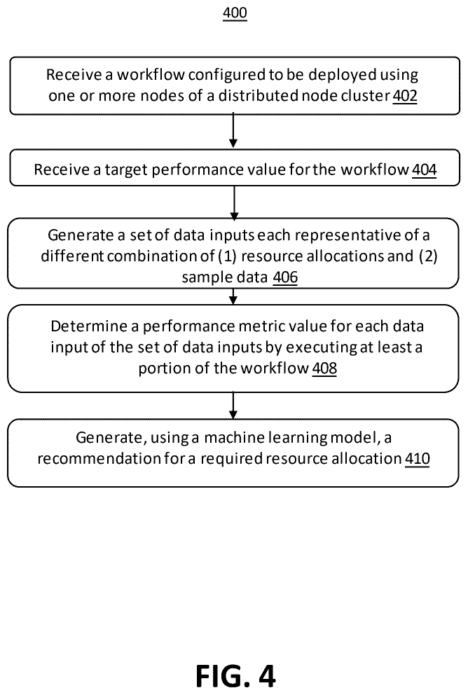

FIG. 4 is a flowchart of an exemplary computer system for dynamically allocating resources for a distributed node network using machine learning models, in accordance with one or more embodiments. For example, the system may use process 400 (e.g., as implemented on one or more system components described above) for dynamically allocating resources for a distributed node network using a machine learning model specific to a particular workflow, e.g., identified by the user.

At step 402, process 400 (e.g., using one or more components described above) includes receiving a workflow configured to be deployed using one or more nodes of a distributed node cluster. For example, the system may receive a workflow comprising computer program code configured to perform one or more processes of the workflow when executed. By doing so, the system can identify the specific workflow to train the machine learning model on, and may also simulate results using specific workflows. This may enable more accurate allocations specific to a particular workflow with a machine learning model that understands the underlying resources that may be needed for the particular workflow to process incoming data.

At step 404, process 400 (e.g., using one or more components described above) includes receiving a target performance value for the workflow. By doing so, the system may train the machine learning model to output a resource allocation based on the input sample data configured to enable the nodes to perform the processing tasks of the workflow at a performance level indicated by the target performance value.

At step 406, process 400 (e.g., using one or more components described above) includes generating a set of data inputs each representative of a different combination of (1) resource allocations and (2) sample data. For example the resource allocations may be used in allocating compute resources to the one or more nodes during performance of the one or more processes, and the sample data may indicate data on which to perform the one or more processes.

At step 408, process 400 includes determining a performance metric value for each data input of the set of data inputs by executing at least a portion of the workflow. For example, the performance metric value for each data input may be determined by executing at least a portion of the workflow to perform the one or more processes on the sample data of a data input using a resource allocation specified in the data input.

At step 410, process 400 (e.g., using one or more components described above) includes generating, using a machine learning model, a recommendation for a required resource allocation. For example, the system may deploy the workflow by executing at least a portion of the computer program code on the one or more nodes of the distributed node cluster and receive a stream of data comprising new sample data to be processed by the workflow. The system may then input the new sample data into the machine learning model to obtain the required resource allocation for processing the new sample data at the one or more nodes.

According to some examples, the machine learning model may be trained to identify the required resource allocation for a given set of data inputs for meeting the target performance value using the set of data inputs and corresponding performance metric values. For example, the machine learning model may be trained by first determining a performance metric value for each data input of the set of data inputs by executing at least a portion of the workflow to perform the one or more processes on the sample data of a data input using a resource allocation specified in the data input. Then the machine learning model may be trained to identify a required resource allocation for a given set of data inputs for meeting the target performance value using the set of data inputs and corresponding performance metric values.

According to some examples, the system may generate one or more commands for automatically scaling the resource allocation to match the required resource allocation. The commands may be automatically applied or applied once a user approves the recommendation, according to some examples.

In some examples, the resource allocation includes a number of computer processing units (CPUs) and generating the one or more commands may include identifying a number of CPUs to use for processing the new sample data based on the resource allocation, determining one or more identifiers corresponding to available CPUs to use in processing the new sample data, and generating at least one command comprising the one or more identifiers and the one or more processes to be executed.

In some examples, the resource allocation includes an amount of memory at each node of the one or more nodes and generating the one or more commands includes identifying the amount of memory to use for processing the new sample data based on the resource allocation, determining, for each node of the one or more nodes, a portion of the amount of memory for processing the new sample data, and generating at least one command for resource allocation, wherein the at least one command identifies each node and a corresponding portion of the amount of memory.

In some examples, the resource allocation includes a network bandwidth amount at each node of the one or more nodes. Generating the one or more commands may include identifying the network bandwidth amount to use for processing the new sample data based on the resource allocation, determining, for each node of the one or more nodes, a portion of the network bandwidth amount for processing the new sample data, and generating at least one command for resource allocation, wherein the at least one command identifies each node and a corresponding portion of the network bandwidth amount.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. receiving a workflow comprising computer program code configured to perform one or more processes of the workflow when executed, wherein the workflow is configured to be deployed using one or more nodes of a distributed node cluster; receiving a target performance value for the workflow; generating a set of data inputs, wherein each data input of the set of data inputs is representative of a different combination of first data and second data, wherein the first data comprises resource allocations for allocating compute resources to the one or more nodes during performance of the one or more processes, and wherein the second data comprises sample data on which to perform the one or more processes; determining a performance metric value for each data input of the set of data inputs by executing at least a portion of the workflow to perform the one or more processes on the sample data of a data input using a resource allocation specified in the data input; and generating, using a machine learning model, a recommendation for a required resource allocation, wherein the machine learning model is trained to identify the required resource allocation for a given set of data inputs for meeting the target performance value using the set of data inputs and corresponding performance metric values.
2. The method of the preceding embodiment, further comprising: deploying the workflow by executing at least a portion of the computer program code on the one or more nodes of the distributed node cluster; receiving a stream of data comprising new sample data to be processed by the workflow; inputting the new sample data into the machine learning model to obtain the required resource allocation for processing the new sample data at the one or more nodes; and generating one or more commands for automatically scaling the resource allocation to match the required resource allocation.
3. The method of any of the preceding embodiments, further comprising: determining the performance metric value for the one or more processes of the workflow; and responsive to determining that the performance metric value does not exceed the target performance value, transmitting a notification to a remote device.
4. The method of any of the preceding embodiments, further comprising: determining a performance metric value for one or more processes of the workflow; and responsive to determining that the performance metric value does not exceed the target performance value, triggering retraining of the machine learning model.
5. The method of any of the preceding embodiments, further comprising: determining the performance metric value for the one or more processes of the workflow; and responsive to determining that the performance metric value does not exceed the target performance value, terminating execution of the workflow.
6. The method of any of the preceding embodiments, wherein the resource allocation comprises a number of computer processing units (CPUs) and wherein generating the one or more commands comprises: identifying a number of CPUs to use for processing the new sample data based on the resource allocation; determining one or more identifiers corresponding to available CPUs to use in processing the new sample data; and generating at least one command comprising the one or more identifiers and the one or more processes to be executed.
7. The method of any of the preceding embodiments, wherein the resource allocation comprises an amount of memory at each node of the one or more nodes and wherein generating the one or more commands comprises: identifying the amount of memory to use for processing the new sample data based on the resource allocation; determining, for each node of the one or more nodes, a portion of the amount of memory for processing the new sample data; and generating at least one command for resource allocation, wherein the at least one command identifies each node and a corresponding portion of the amount of memory.
8. The method of any of the preceding embodiments, further comprising: wherein the resource allocation comprises a network bandwidth amount at each node of the one or more nodes and wherein generating the one or more commands comprises: identifying the network bandwidth amount to use for processing the new sample data based on the resource allocation; determining, for each node of the one or more nodes, a portion of the network bandwidth amount for processing the new sample data; and generating at least one command for resource allocation, wherein the at least one command identifies each node and a corresponding portion of the network bandwidth amount.
9. The method of any of the preceding embodiments, obtaining, from a remote device, a user input indicative of a parameter on which to vary the sample data of each data input of the set of data inputs.
10. The method of any of the preceding embodiments, wherein the parameter comprises an amount of data to be processed and wherein generating the set of data inputs comprises: generating a set of synthetic sample data; and referencing varying amounts of sample data from the set of synthetic sample data for processing for data inputs of the set of data inputs.
11. The method of any of the preceding embodiments, wherein the parameter comprises an amount of data to be processed and wherein generating the set of data inputs comprises: accessing, from storage, one or more preexisting sets of sample data; and referencing varying amounts of sample data from the one or more preexisting sets of sample data for processing for data inputs of the set of data inputs.
12. A tangible, non-transitory, machine-readable medium storing instructions that, when executed by a data processing apparatus, cause the data processing apparatus to perform operations comprising those of any of embodiments 1-11.
13. A system comprising: one or more processors; and memory storing instructions that, when executed by the one or more processors, cause the processors to effectuate operations comprising those of any of embodiments 1-11.
14. A system comprising means for performing any of embodiments 1-11.
15. A system comprising cloud-based circuitry for performing any of embodiments 1-11.

What is claimed is:

1. A system for dynamically allocating resources for a distributed node network using machine learning models, the system comprising:
one or more processors; and
a non-transitory, computer-readable medium comprising instructions that, when executed by the one or more processors, causes operations comprising:
receiving a workflow comprising computer program code configured to perform one or more processes of the workflow when executed, wherein the workflow is configured to be deployed using one or more nodes of a distributed node cluster;
receiving a target performance value for the workflow;
generating a set of data inputs, wherein each data input of the set of data inputs is representative of a different combination of first data and second data, wherein the first data comprises resource allocations for allocating compute resources to the one or more nodes during performance of the one or more processes, and wherein the second data comprises sample data on which to perform the one or more processes;
determining a performance metric value for each data input of the set of data inputs by executing at least a portion of the workflow to perform the one or more processes on the sample data of a data input using a resource allocation specified in the data input;
training a machine learning model to identify a required resource allocation for a given set of data inputs for meeting the target performance value using the set of data inputs and corresponding performance metric values;
deploying the workflow by executing at least a portion of the computer program code on the one or more nodes of the distributed node cluster;
receiving a stream of data comprising new sample data to be processed by the workflow;
inputting the new sample data into the machine learning model to obtain the required resource allocation for processing the new sample data at the one or more nodes; and
generating, using the machine learning model, a recommendation for the required resource allocation, wherein the machine learning model is trained to identify the required resource allocation for the given set of data inputs for meeting the target performance value using the set of data inputs and the corresponding performance metric values.

2. A method for dynamically allocating resources for a distributed node network using machine learning models, the method comprising:
receiving a workflow comprising computer program code configured to perform one or more processes of the workflow when executed, wherein the workflow is configured to be deployed using one or more nodes of a distributed node cluster;
receiving a target performance value for the workflow;
generating a set of data inputs, wherein each data input of the set of data inputs is representative of a different combination of first data and second data, wherein the first data comprises resource allocations for allocating compute resources to the one or more nodes during performance of the one or more processes, and wherein the second data comprises sample data on which to perform the one or more processes;
determining a performance metric value for each data input of the set of data inputs by executing at least a portion of the workflow to perform the one or more processes on the sample data of a data input using a resource allocation specified in the data input; and
generating, using a machine learning model, a recommendation for a required resource allocation, wherein the machine learning model is trained to identify the required resource allocation for a given set of data inputs for meeting the target performance value using the set of data inputs and corresponding performance metric values.

3. The method of claim 2, further comprising:
deploying the workflow by executing at least a portion of the computer program code on the one or more nodes of the distributed node cluster;
receiving a stream of data comprising new sample data to be processed by the workflow;
inputting the new sample data into the machine learning model to obtain the required resource allocation for processing the new sample data at the one or more nodes; and
generating one or more commands for automatically scaling the resource allocation to match the required resource allocation.

4. The method of claim 3, further comprising:
determining the performance metric value for the one or more processes of the workflow; and
responsive to determining that the performance metric value does not exceed the target performance value, transmitting a notification to a remote device.

5. The method of claim 3, further comprising:
determining a performance metric value for one or more processes of the workflow; and
responsive to determining that the performance metric value does not exceed the target performance value, triggering retraining of the machine learning model.

6. The method of claim 3, further comprising:
determining the performance metric value for the one or more processes of the workflow; and
responsive to determining that the performance metric value does not exceed the target performance value, terminating execution of the workflow.

7. The method of claim 3, wherein the resource allocation comprises a number of computer processing units (CPUs) and wherein generating the one or more commands comprises:
identifying a number of CPUs to use for processing the new sample data based on the resource allocation;
determining one or more identifiers corresponding to available CPUs to use in processing the new sample data; and
generating at least one command comprising the one or more identifiers and the one or more processes to be executed.

8. The method of claim 3, wherein the resource allocation comprises an amount of memory at each node of the one or more nodes and wherein generating the one or more commands comprises:
identifying the amount of memory to use for processing the new sample data based on the resource allocation;
determining, for each node of the one or more nodes, a portion of the amount of memory for processing the new sample data; and
generating at least one command for resource allocation, wherein the at least one command identifies each node and a corresponding portion of the amount of memory.

9. The method of claim 3, wherein the resource allocation comprises a network bandwidth amount at each node of the one or more nodes and wherein generating the one or more commands comprises:
identifying the network bandwidth amount to use for processing the new sample data based on the resource allocation;
determining, for each node of the one or more nodes, a portion of the network bandwidth amount for processing the new sample data; and
generating at least one command for resource allocation, wherein the at least one command identifies each node and a corresponding portion of the network bandwidth amount.

10. The method of claim 2, further comprising:
obtaining, from a remote device, a user input indicative of a parameter on which to vary the sample data of each data input of the set of data inputs.

11. The method of claim 10, wherein the parameter comprises an amount of data to be processed and wherein generating the set of data inputs comprises:
generating a set of synthetic sample data; and
referencing varying amounts of sample data from the set of synthetic sample data for processing for data inputs of the set of data inputs.

12. The method of claim 10, wherein the parameter comprises an amount of data to be processed and wherein generating the set of data inputs comprises:
accessing, from storage, one or more preexisting sets of sample data; and
referencing varying amounts of sample data from the one or more preexisting sets of sample data for processing for data inputs of the set of data inputs.

13. One or more non-transitory, computer-readable media comprising instructions recorded thereon that, when executed by one or more processors, cause operations for dynamically allocating resources for a distributed node network using machine learning models, comprising:
receiving a workflow comprising computer program code configured to perform one or more processes of the workflow when executed, wherein the workflow is configured to be deployed using one or more nodes of a distributed node cluster;
receiving a target performance value for the workflow;
generating a set of data inputs, wherein each data input of the set of data inputs is representative of a different combination of (a) resource allocation for allocating compute resources to the one or more nodes during performance of the one or more processes and (b) sample data on which to perform the one or more processes;
determining a performance metric value for each data input of the set of data inputs by executing at least a portion of the workflow to perform the one or more processes on the sample data of a data input using the resource allocation specified in the data input; and
training a machine learning model to identify a required resource allocation for a given set of data inputs for meeting the target performance value using the set of data inputs, corresponding performance metric value, and the target performance value.

14. The one or more non-transitory, computer-readable media of claim 13, wherein the instructions further cause operations comprising:
deploying the workflow by executing at least a portion of the computer program code on the one or more nodes of the distributed node cluster;
receiving a stream of data comprising new sample data to be processed by the workflow;
inputting the new sample data into the machine learning model to obtain the required resource allocation for processing the new sample data at the one or more nodes; and
generating one or more commands for automatically scaling the resource allocation to match the required resource allocation.

15. The one or more non-transitory, computer-readable media of claim 14, wherein the instructions further cause operations comprising:
determining the performance metric value for the one or more processes of the workflow; and
responsive to determining that the performance metric value does not exceed the target performance value, transmitting a notification to a remote device.

16. The one or more non-transitory, computer-readable media of claim 14, wherein the instructions further cause operations comprising:
determining the performance metric value for the one or more processes of the workflow; and
responsive to determining that the performance metric value does not exceed the target performance value, triggering retraining of the machine learning model.

17. The one or more non-transitory, computer-readable media of claim 14, wherein the resource allocation comprises a number of computer processing units (CPUs) and wherein generating the one or more commands comprises:
identifying a number of CPUs to use for processing the new sample data based on the resource allocation;
determining one or more identifiers corresponding to available CPUs to use in processing the new sample data; and
generating at least one command comprising the one or more identifiers and the one or more processes to be executed.

18. The one or more non-transitory, computer-readable media of claim 14, wherein the resource allocation comprises an amount of memory at each node of the one or more nodes and wherein generating the one or more commands comprises:
identifying the amount of memory to use for processing the new sample data based on the resource allocation;
determining, for each node of the one or more nodes, a portion of the amount of memory for processing the new sample data; and
generating at least one command for resource allocation, wherein the at least one command identifies each node and a corresponding portion of the amount of memory.

19. The one or more non-transitory, computer-readable media of claim 14, wherein the instructions further cause operations comprising:
obtaining, from a remote device, a user input indicative of a parameter on which to vary the sample data of each data input of the set of data inputs.

20. The one or more non-transitory, computer-readable media of claim 19, wherein the parameter comprises an amount of data to be processed and wherein generating the set of data inputs comprises:
generating a set of synthetic sample data; and
referencing varying amounts of sample data from the set of synthetic sample data for processing for data inputs of the set of data inputs.
